(19) United States
(12) Patent Application Publication
(10) Pub. No.: US 2011/0122073 A1
(43) Pub. Date: May 26, 2011

(54) DRIVING DEVICE OF PASSIVE MATRIX BISTABLE DISPLAY AND REAL-TIME TOUCH INPUT DISPLAY METHOD THEREOF

(75) Inventors: Chih-Jen Chen, Tainan County (TW); Chien-Chih Hsu, Miaoli County (TW); Yun-Shuo Chang, Taoyuan County (TW); Cheng-Chung Wu, Taichung County (TW)

(73) Assignee: INDUSTRIAL TECHNOLOGY RESEARCH INSTITUTE, Hsinchu (TW)

(21) Appl. No.: 12/719,016

(22) Filed: Mar. 8, 2010

(30) Foreign Application Priority Data
Nov. 25, 2009 (TW) 98140279

(51) Int. Cl. G06F 3/038; G06F 3/041

(52) U.S. Cl. 345/173; 345/214

(57) ABSTRACT

A driving device of a passive matrix (PM) bistable display and a real-time touch input display method thereof are provided. The real-time touch input display method includes following steps. First, a touch event of a touch panel is detected to obtain a touch coordinate. When the touch event occurs, one of a plurality of scan lines of the PM bistable display is selected as a corresponding scan line according to the touch coordinate, and a corresponding pixel on the corresponding scan line is driven according to the touch coordinate.

### CROSS-REFERENCE TO RELATED APPLICATION

This application claims the priority benefit of Taiwan application serial no. 98140279, filed on Nov. 25, 2009. The entirety of the above-mentioned patent application is hereby incorporated by reference herein and made a part of specification.

### BACKGROUND OF THE INVENTION

1. Technical Field

The disclosure relates to a driving device of a passive matrix (PM) bistable display and a real-time touch input display method thereof.

2. Background

Touch panel is one of today's most popular input devices. All existing touch input display techniques are realized in active matrix (AM) display panels. In a touch input display technique implemented in an AM display panel, a real-time touch input display effect is achieved by repeatedly updating the entire frames. Due to the slow response of bistable display medium, the existing touch input display techniques are not applicable to passive matrix (PM) bistable displays.

FIG. 1A is a block diagram of a conventional PM bistable display 100. The PM bistable display 100 includes a display panel 130. The display panel 130 has a plurality of scan lines S(1), S(2), S(3), S(4), S(5), S(6), . . . , and S(N) and a plurality of data lines D(1), D(2), D(3), D(4), . . . , D(M-1), and D(M). A scan driver 120 is electrically connected to the scan lines S(1)-S(N), and a data driver 110 is electrically connected to the data lines D(1)-D(M). The scan driver 120 sequentially drives the scan lines S(1)-S(N). Correspondingly, the data driver 110 respectively writes a plurality of pixel data into the pixels via the data lines D(1)-D(M) according to the timing for driving the scan lines S(1)-S(N). For example, when the scan driver 120 drives the scan line S(1), the data driver 110 correspondingly writes a pixel data into the pixel PX via the data line D(M).

“Bistable display” generally refers to a type of display techniques, and there are many different techniques for accomplishing the bistable display technique, such as electronic ink (E-Ink) display, cholesteric liquid crystal display (ChLCD), electro-phoretic display (EPD), electrowetting display (EWD), quick response-liquid powder display (QR-LPD), or other bistable display techniques that are not mentioned in the disclosure. It is called “bistable” because a bistable display unit (a pixel) constantly remains in either a “bright state” or a “dark state” when no voltage is supplied. Taking an E-Ink display as an example, positively charged white particles and negatively charged black particles are used as the bistable display medium in the electronic ink in the pixel PX. When a sufficient negative electric field is supplied (i.e., when the voltage on the scan line S(1) is lower than the voltage on the data line D(M)), the black particles in the pixel PX move down to the bottom layer while the white particles move up to the top layer and accordingly form a white dot on the display panel 130. In this case, the pixel PX is in the “bright state”. Contrarily, if a sufficient positive electric field is supplied (i.e., the voltage on the scan line S(1) is higher than the voltage on the data line D(M)), the black particles move to the top layer and form a black dot on the display panel 130. In this case, the pixel PX is in the “dark state”. When no voltage (electric field) is supplied, the pixel PX remains in the “bright state” or the “dark state”.

One advantage of adopting the bistable display technique in a display is that a frame can be memorized even with no voltage is supplied and accordingly the power consumption is reduced. Ideally, a PM bistable display consumes hundreds of times less power than a conventional AM liquid crystal display. PM bistable display offers bistable states, low power consumption, simple fabricating process, and low cost therefore is very competitive among all display products. However, it usually takes a very long time to update an entire frame because of the slow response of the bistable display medium. Thus, PM bistable display is most suitable for such displays that the frames are not to be updated frequently, such as cell phones, e-books, or even large-scale electronic display panels. All existing touch input display techniques are realized in AM display panels, wherein entire frames are repeatedly updated. If an existing touch input display technique is implemented in a PM bistable display, it will take a very long time to update an entire frame due to the slow response of the bistable display medium, and accordingly the real-time touch input display effect cannot be accomplished.

### SUMMARY

According to an embodiment, a real-time touch input display method of a PM bistable display is provided, wherein the PM bistable display has a plurality of scan lines and a plurality of data lines. The real-time touch input display method includes following steps. First, a touch event of a touch panel is detected to obtain at least one touch coordinate. When the touch event occurs, one of the scan lines is selected as a corresponding scan line according to the touch coordinate, and a corresponding pixel on the corresponding scan line is driven according to the touch coordinate.

According to an embodiment, a driving device of a PM bistable display is provided, wherein the PM bistable display has a plurality of scan lines and a plurality of data lines. The driving device includes a touch detection unit and a display control unit. The touch detection unit detects a touch event of a touch panel to obtain a touch coordinate. The display control unit drives the PM bistable display to display a frame. When the touch event occurs, the display control unit selects one of the scan lines as a corresponding scan line according to the touch coordinate provided by the touch detection unit and drives a corresponding pixel on the corresponding scan line according to the touch coordinate.

### BRIEF DESCRIPTION OF THE DRAWINGS

The accompanying drawings are included to provide a further understanding of the embodiment, and are incorporated in and constitute a part of this specification. The drawings illustrate embodiments and, together with the description, serve to explain the principles of the embodiment.

FIG. 1A is a block diagram of a conventional passive matrix (PM) bistable display 100.

FIG. 1B is a driving timing diagram of a conventional touch input display method.

FIG. 1C is a driving timing diagram of a real-time touch input display method according to an embodiment.

FIG. 2 is a flowchart of a real-time touch input display method according to an embodiment.

FIG. 3 is a diagram of a driving device of a PM bistable display according to an embodiment.

FIG. 4 is a flowchart of a real-time touch input display method according to another embodiment.

FIG. 5 is a flowchart of a real-time touch input display method according to yet another embodiment.

FIG. 6 is a diagram of a driving device of a PM bistable display according to still another embodiment.

FIG. 7 is a diagram of a driving device of a PM bistable display according to yet still another embodiment.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

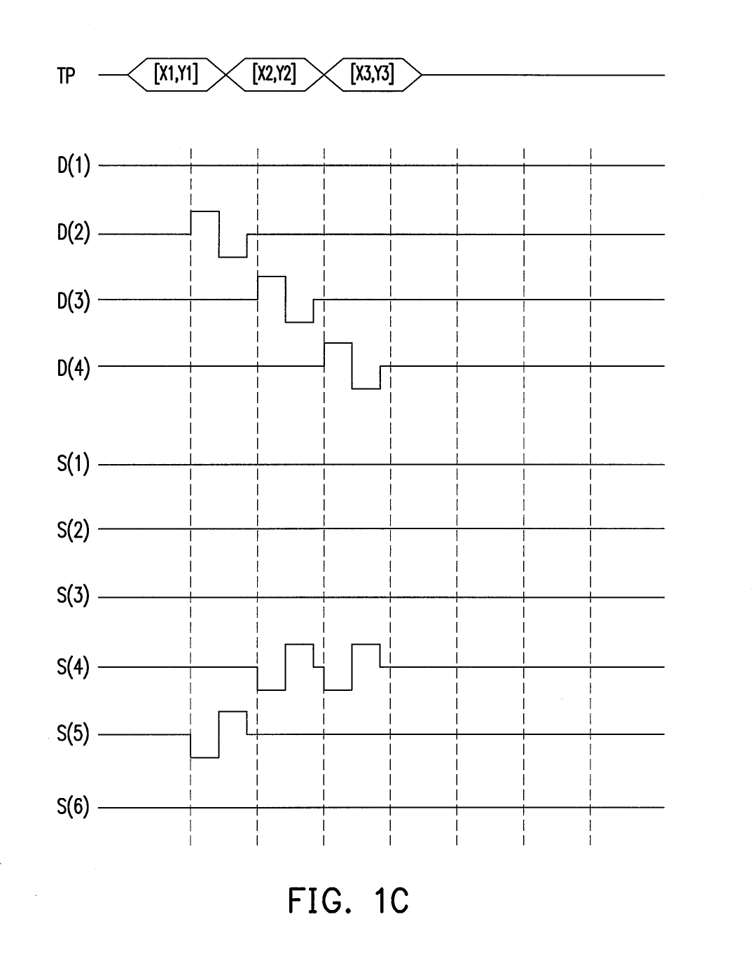

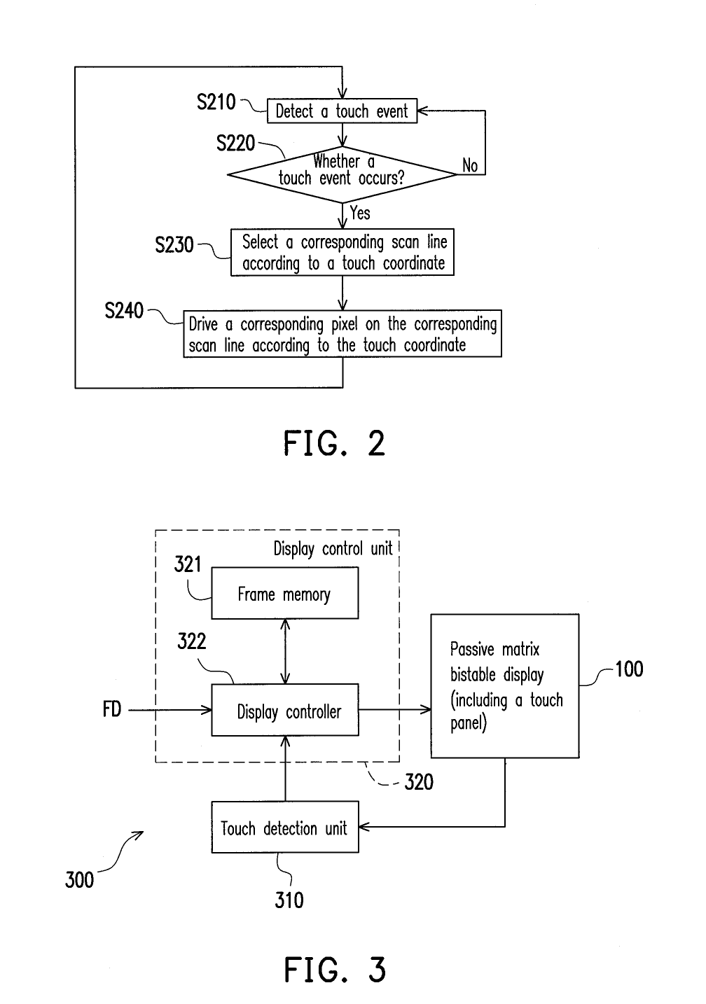

FIG. 2 is a flowchart of a real-time touch input display method according to an embodiment. FIG. 3 is a diagram of a driving device 300 of a PM bistable display 100 according to an embodiment. The PM bistable display 100 may be an electronic ink (E-Ink) display, a cholesteric liquid crystal display (ChLCD), an electro-phoretic display (EPD), an electrowetting display, (EWD), a quick response-liquid powder display (QR-LPD), or any other type of PM bistable display unmentioned in the disclosure. The PM bistable display 100 has a plurality of scan lines and a plurality of data lines. The driving device 300 includes a data driver 110, a scan driver 120, a touch detection unit 310, and a display control unit 320. In the embodiment, the PM bistable display 100 includes a touch panel, and the touch detection unit 310 detects the touch panel. However, the detection technique for detecting the touch panel is not limited in the embodiment, and the implementation of the touch panel and the detection technique adopted by the touch detection unit 310 are well known techniques in the industry therefore will not be described herein.

Referring to FIG. 2 and FIG. 3, the touch detection unit 310 detects touch event of the touch panel of the PM bistable display 100 (step S210) to determine whether a touch event occurs on the touch panel (step S220). When the touch event occurs (for example, a user touches the touch panel of the PM bistable display 100 with his finger), the touch detection unit 310 obtains one or multiple corresponding touch coordinates.

The display control unit 320 controls the scan driver 120 and the data driver 110 according to a frame data FD it receives, so as to drive the PM bistable display 100 to display a frame. When the touch event occurs, the touch detection unit 310 provides a touch coordinate TP to the display control unit 320. Thus, when the touch event occurs, the display control unit 320 selects a corresponding one of the scan lines S(1)-S(N) (referred to as a corresponding scan line thereinafter) of the PM bistable display 100 according to the touch coordinate TP provided by the touch detection unit 310 (step S230) and drives a corresponding pixel on the corresponding scan line according to the touch coordinate TP (step S240). The touch detection unit 310 constantly detects the touch panel and constantly determines whether the touch event occurs. Accordingly, the procedure returns to step S210 after step S240.

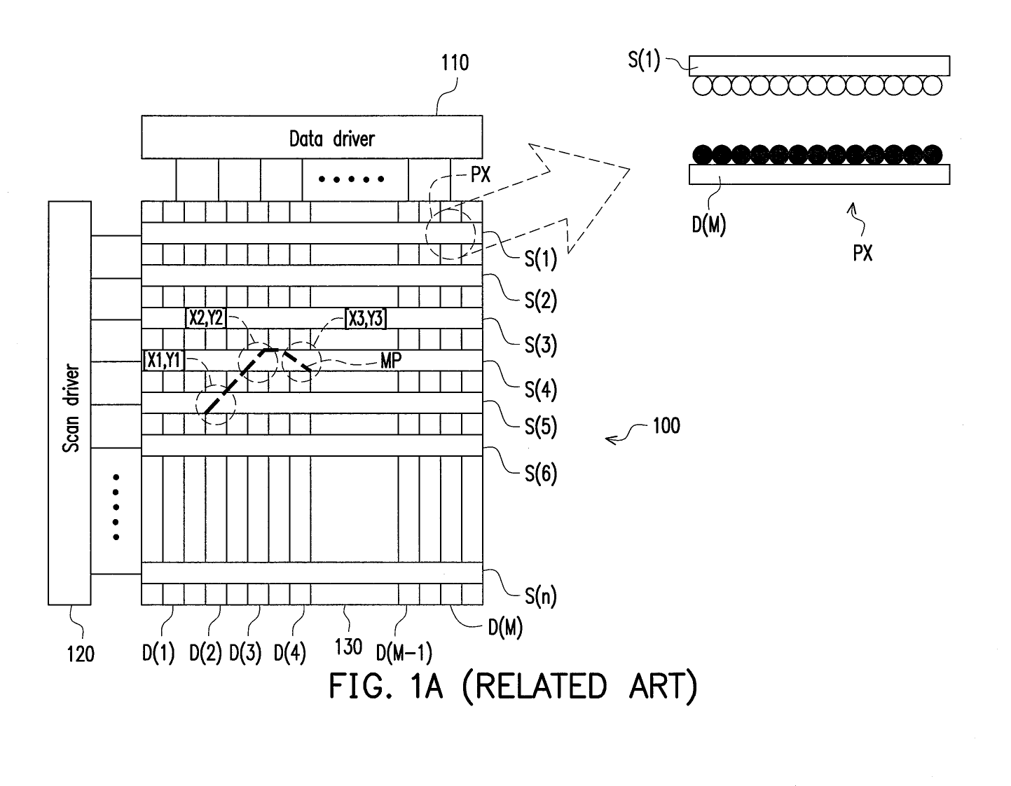

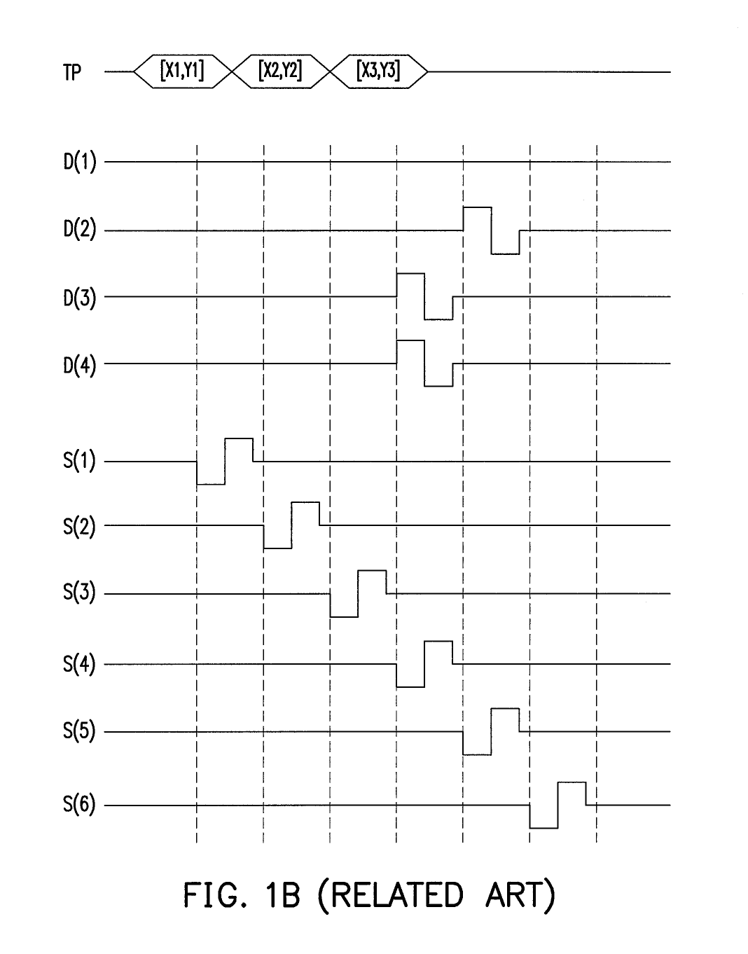

For example, if the touch coordinate TP provided by the touch detection unit 310 indicates that the moving path of the touch point on the touch panel is the path MP illustrated in FIG. 1A, the values of the touch coordinate TP are sequentially [x1,y1], [x2,y2], and [x3,y3]. FIG. 1B is a driving timing diagram of a conventional touch input display method. It should be noted that the driving waveform in FIG. 1B is an example, and the actual driving waveform should be determined according to the bistable display medium and the design of the PM bistable display 100. As shown in FIG. 1B, in the conventional touch input display technique, after obtaining the values [x1,y1], [x2,y2], and [x3,y3] of the touch coordinate TP, the scan driver 120 sequentially drives all the scan lines S(1)-S(N) and at the same time, the data driver 110 correspondingly drives all the data lines D(1)-D(M) so as to update the entire frame (all the pixels). Namely, in the conventional touch input display technique, no corresponding scan line is selected. Instead, the scan driver 120 sequentially drives all the scan lines S(1)-S(N). In other words, in the conventional touch input display technique, all the pixels are driven even tough the touch event is to transform only three pixels corresponding to the touch coordinates [x1,y1], [x2,y2], and [x3,y3] on the PM bistable display 100 into the “dark state” while maintain other pixels in the “bright state”.

Unlike in the conventional technique, in the real-time touch input display method disclosed in the embodiment, the display control unit 320 selects and drives the corresponding scan line among all the scan lines and the corresponding data line. For example, the values of the touch coordinate TP provided by the touch detection unit 310 are [x1,y1], [x2,y2], and [x3,y3], and the moving path MP of the touch point is as shown in FIG. 1A. FIG. 1C is a driving timing diagram of a real-time touch input display method according to an embodiment. It should be noted that the driving waveform illustrated in FIG. 1C is an example, and the actual driving waveform should be determined according to the bistable display medium and the design of the PM bistable display 100. As shown in FIG. 1C, when the display control unit 320 obtains the value [x1,y1] of the touch coordinate TP, the display control unit 320 selects and drives the corresponding scan line S(5) among the scan lines S(1)-S(N) of the PM bistable display 100 and drives the data line D(2) according to the touch coordinate [x1,y1]. Thus, the corresponding pixel (the touch coordinate thereof is [x1,y1]) on the corresponding scan line S(5) is transformed into the dark state, and no other pixel is driven. Next, when the display control unit 320 obtains the value [x2,y2] of the touch coordinate TP, the display control unit 320 selects and drives the corresponding scan line S(4) and drives the data line D(3) according to the touch coordinate [x2,y2]. Thus, the corresponding pixel (the touch coordinate thereof is [x2,y2]) on the corresponding scan line S(4) is transformed into the dark state, and no other pixel is driven. When the display control unit 320 obtains the value [x3,y3] of the touch coordinate TP, the display control unit 320 selects and drives the corresponding scan line S(4) and drives the data line D(4) according to the touch coordinate [x3,y3]. Thus, the corresponding pixel (the touch coordinate thereof is [x3,y3]) on the corresponding scan line S(4) is transformed into the dark state, and no other pixel is driven.

As described above, in the embodiment, when a touch event occurs, the display control unit 320 drives the pixel corresponding to the touched position. Thereby, a user can see the updated frame during the handwriting input process, which brings a real-time sensation to the user.

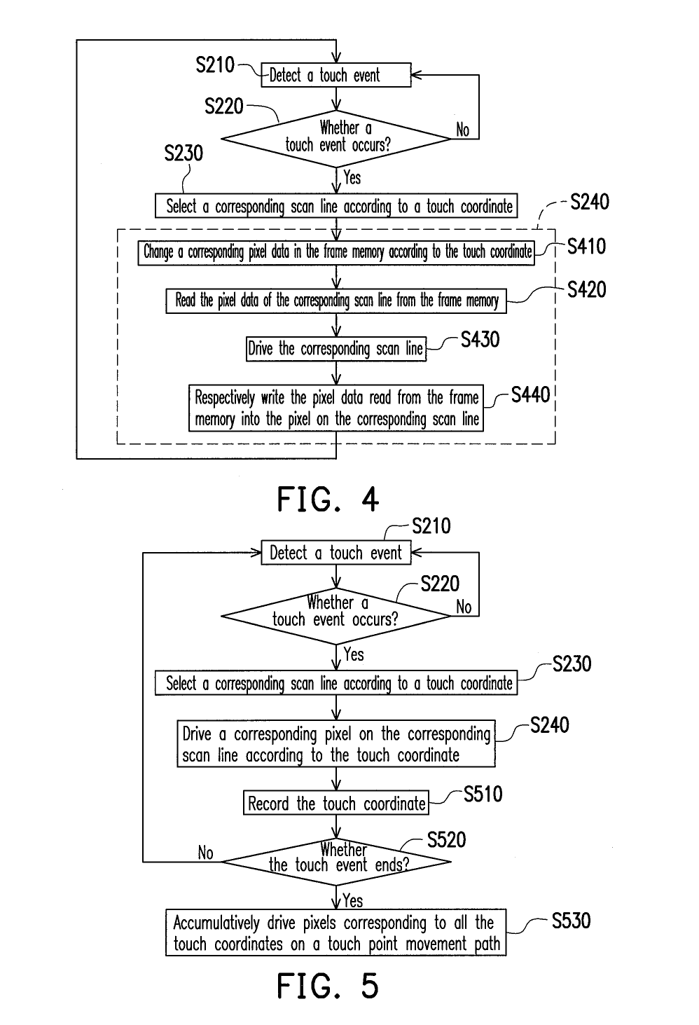

The display control unit 320 can be implemented through any technique according to the actual design requirement. For example, as shown in FIG. 3, the display control unit 320 includes a frame memory 321 and a display controller 322. The display controller 322 is coupled to the frame memory 321 and the touch detection unit 310. As shown in FIG. 4, the step S240 is further divided into steps S410-S440. Below, these steps will be described with reference to both FIG. 3 and FIG. 4.

Based on the requirement of different application, the display controller 322 may be a timing controller and/or a scaler. In some applications, the data driver 110 and/or the scan driver 120 may be embedded in the timing controller. The frame memory 321 records the pixel data of all pixels of the PM bistable display 100. The display controller 322 stores the received frame data FD into the frame memory 321. Due to the characteristic of PM bistable display, the PM bistable display 100 can display a frame without having to constantly drive it. Thus, the display controller 322 updates the states of all the pixels according to the pixel data recorded in the frame memory 321 at regular intervals (for example, every 10 minutes or longer).

In step S410, the display controller 322 changes the corresponding one of the pixel data (referred to as a corresponding pixel data thereinafter) recorded in the frame memory 321 according to the touch coordinate provided by the touch detection unit 310. For example, if the touch coordinate provided by the touch detection unit 310 indicates that the touched position is at the pixel PX, the display controller 322 changes the pixel data of the pixel PX recorded in the frame memory 321 (for example, changes the pixel data from “bright state” to “dark state”).

After step S410, the display controller 322 reads all the pixel data corresponding to the corresponding scan line selected from the frame memory 321 in step S230 (step S420). Next, the display controller 322 drives the corresponding scan line (for example, the scan line S(1)) selected in step S230, so as to turn on the pixels on the corresponding scan line (step S430). Meanwhile, the display controller 322 drives the data lines D(1)-D(M) to respectively write the pixel data read in step S420 into the pixels on the corresponding scan line (step S440). It should be noted that in other embodiments, a part of the pixel data on the corresponding scan line may be read in step S420, and correspondingly, some of the data lines may be selected and driven in step S440.

FIG. 5 is a flowchart of a real-time touch input display method according to yet another embodiment. The steps S210-S240 in FIG. 5 can be referred to the description of FIG. 2 therefore will not be described herein. Referring to FIG. 3 and FIG. 5, after step S240, the display controller 322 records the touch coordinate of the touch point into the frame memory 321 during the touch event (step S510). Next, the display controller 322 determines whether the touch event ends through the touch detection unit 310 (step S520). For example, whether the user's finger leaves the touch panel is determined. If the touch event does not end yet, steps S210-S240 and step S510 are executed again until the touch event ends. Thus, a plurality of touch coordinates of the moving path of the touch point on the touch panel is recorded in step S510.

After the touch event ends, the display controller 322 drives the pixels corresponding to the touch coordinates recorded in the frame memory 321 during the touch event at least once again (i.e., cumulatively driving) according to these touch coordinates (step S530). The method for driving the corresponding pixels in step S530 can be referred to the descriptions of steps S230 and S240. For example, it is assumed herein that the touch coordinates of the moving path of the touch point during the touch event are [x1,y1], [x2,y2], and [x3,y3]. The display controller 322 has already driven the pixels corresponding to the touch coordinates [x1,y1], [x2,y2], and [x3,y3] during the touch event. After the touch event ends (i.e., after driving the corresponding pixels on the corresponding scan line according to all the touch coordinates), the display controller 322 executes step S530 to drive the pixels corresponding to the touch coordinates [x1,y1], [x2,y2], and [x3,y3] for the second time (or more times). In step S530, the corresponding pixels on the moving path of the touch point can be repeatedly driven for many times according to the actual design requirement. The repeated driving of the pixels on the moving path of the touch point is referred to as cumulative driving.

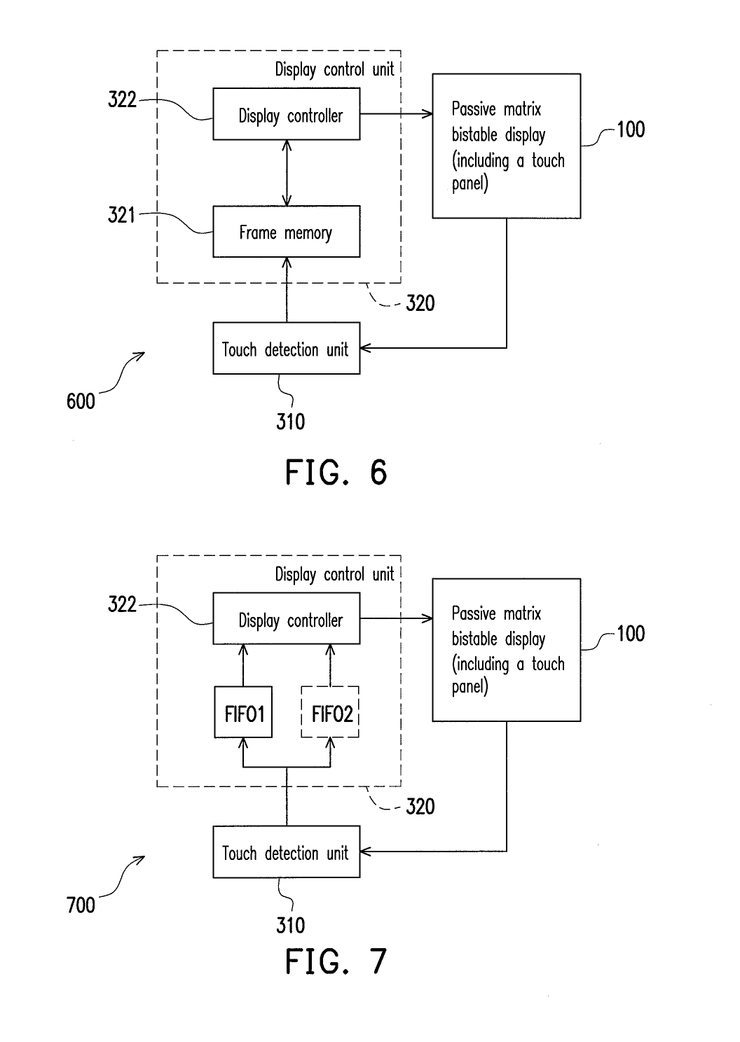

The driving device illustrated in FIG. 3 is an example, and the display control unit 320 may be implemented through any technique by those having ordinary knowledge in the art according to the actual design requirement and the disclosure. FIG. 6 is a diagram of a driving device 600 of a PM bistable display 100 according to still another embodiment. Please refer to the description of FIG. 3 for any aspect of the embodiment that is not described herein. In the driving device 600, the display control unit 320 includes a frame memory 321 and a display controller 322. The frame memory 321 is coupled to the touch detection unit 310 for receiving and recording a touch coordinate provided by the touch detection unit 310. The frame memory 321 changes a corresponding pixel data among a plurality of pixel data recorded therein according to the touch coordinate. The display controller 322 is coupled to the frame memory 321. After the frame memory 321 changes the corresponding pixel data, the display controller 322 reads all the pixel data of the scan line corresponding to the touch point from the frame memory 321, drives the corresponding scan line to turn on the pixels on the corresponding scan line, and drives the data lines to respectively write the pixel data read from the frame memory 321 into the pixels on the corresponding scan line. The contents described with reference to FIG. 2, FIG. 4, and FIG. 5 are applicable to the embodiment described above.

FIG. 7 is a diagram of a driving device 700 of a PM bistable display 100 according to yet still another embodiment. Please refer to the description of FIG. 3 for any aspect of the embodiment that is not described herein. In the driving device 700, the display control unit 320 includes a first memory (for example, a first input first output (FIFO) memory FIFO1) and the display controller 322. The first FIFO memory FIFO1 is coupled to the touch detection unit 310. During a touch event, the first FIFO memory FIFO1 records a plurality of touch coordinates on a moving path of a touch point on the touch panel. The display controller 322 is coupled to the first FIFO memory FIFO1. During the touch event, the display controller 322 selects one of the scan lines S(1)-S(N) as the corresponding scan line according to the touch coordinates output by the first FIFO memory FIFO1 and drives the corresponding pixel on the corresponding scan line according to the touch coordinates output by the first FIFO memory FIFO1. For example, assuming that during the touch event, the touch coordinates on the moving path of the touch point are [x1,y1], [x2,y2], and [x3,y3], the touch detection unit 310 sequentially sends the touch coordinates [x1,y1], [x2,y2], and [x3,y3] to the first FIFO memory FIFO1. Thus, the display controller 322 selects to drive the scan lines corresponding to the touch coordinates [x1,y1], [x2,y2], and [x3,y3] from the scan lines S(1)-S(N) and drives the corresponding pixels according to the touch coordinates [x1,y1], [x2,y2], and [x3,y3]. The contents described with reference to FIG. 2 and FIG. 4 are applicable to the embodiment described above.

A second memory (for example, a second FIFO memory FIFO2) may be disposed in the display control unit 320 according to the actual design requirement. The second FIFO memory FIFO2 is coupled between the touch detection unit 310 and the display controller 322. Similar to the first FIFO memory FIFO1, during the touch event, the second FIFO memory FIFO2 records the touch coordinates on the moving path of the touch point. After the touch event ends and driving the corresponding pixel on the corresponding scan line according to all the touch coordinates output by the first FIFO memory FIFO1 is completed, the display controller 322 selects and drives the corresponding scan line from the scan lines S(1)-S(N) according to the touch coordinates output by the second FIFO memory FIFO2 and drives the corresponding pixel according to the touch coordinates output by the second FIFO memory FIFO2. For example, assuming that during the touch event, the touch coordinates on the moving path of the touch point are [x1,y1], [x2,y2], and [x3,y3], the touch detection unit 310 sequentially sends the touch coordinates [x1,y1], [x2,y2], and [x3,y3] to the memories FIFO1 and FIFO2. Thus, the display controller 322 can select and drive some pixels of the PM bistable display 100 according to the touch coordinates [x1,y1], [x2,y2], and [x3,y3] provided by the first FIFO memory FIFO1 during the touch event. After the touch event ends, the display controller 322 can select and drive some pixels of the PM bistable display 100 for the second time (or more times) according to the touch coordinates [x1,y1], [x2,y2], and [x3,y3] provided by the second FIFO memory FIFO2. The content described with reference to FIG. 5 is applicable to the embodiment described above.

Three or more FIFO memories may be disposed in the display control unit 320 according to the actual design requirement. Herein it is assumed that a first FIFO memory FIFO1, a second FIFO memory FIFO2, and a third FIFO memory (not shown) are disposed in the display control unit 320. The coupling and operation of the third FIFO memory can be referred to those of the second FIFO memory FIFO2. Similar to the first FIFO memory FIFO1, both the second FIFO memory FIFO2 and the third FIFO memory (not shown) record the touch coordinates on the moving path of the touch point during the touch event. As described above, after the touch event ends, the display controller 322 can select and drive some pixels of the PM bistable display 100 for the second time according to the touch coordinates provided by the second FIFO memory FIFO2. After the second driving operation is finished, the display controller 322 can select and drive some pixels of the PM bistable display 100 for the third time according to the touch coordinates provided by the third FIFO memory (not shown). Accordingly, N FIFO memories can be connected between the touch detection unit 310 and the display controller 322 in parallel if the PM bistable display 100 is expected to drive the pixels on the moving path for N times.

As described above, in embodiments described above, when a touch event occurs, instead of sequentially driving all the scan lines, some of the scan lines of the PM bistable display 100 are selected and driven according to touch coordinates on the touch panel. Thus, when the touch event occurs, it is not needed to update the pixels of the entire frame. Instead, a small portion of the pixels of the PM bistable display 100 is driven and accordingly the frame updating speed is greatly increased. Thereby, a user can see changes of the frame on the moving path of the touch point when the user uses the touch input display device, which brings a real-time sensation to the user. In addition, in some embodiments, a PM bistable display is driven through a cumulative driving technique. Namely, the time of driving each pixel is divided into a plurality of stages, and the same pixel is driven for multiple times by using the same pixel data. In an embodiment adopting the cumulative driving technique, after the user finishes a touch event, the display control unit 320 drives some corresponding pixels in the PM bistable display 100 again along the moving path of the touch point. Thereby, by using the cumulative driving technique, frame response speed is further increased and a real-time frame change is brought to the user.

It will be apparent to those skilled in the art that various modifications and variations can be made to the structure of the embodiment without departing from the scope or spirit of the embodiment. In view of the foregoing, it is intended that the embodiment cover modifications and variations of this invention provided they fall within the scope of the following claims and their equivalents.

As described above, when a touch event occurs, instead of sequentially driving all the scan lines, a corresponding scan line is selected from a plurality of scan lines of the PM bistable display and driven according to the touch coordinate on the touch panel. Thus, when the touch event occurs, it is not needed to update the pixels on the entire panel but a small portion of pixels of the PM bistable display is driven so that the update rate is significantly increased. Thereby, when a user uses the touch panel, the user can notice the changes of the frame along the moving path of the touch point, which brings a real-time sensation to the user.

What is claimed is:

1. A real-time touch input display method of a passive matrix (PM) bistable display, wherein the PM bistable display has a plurality of scan lines and a plurality of data lines, the real-time touch input display method comprising:
detecting a touch event of a touch panel to obtain at least one touch coordinate;
selecting one of the scan lines as a corresponding scan line according to the touch coordinate when the touch event occurs; and
driving a corresponding pixel on the corresponding scan line according to the touch coordinate when the touch event occurs.

2. The real-time touch input display method according to claim 1 further comprising:
providing a frame memory, wherein the frame memory records a plurality of pixel data of the touch panel; and
changing a corresponding pixel data among the pixel data recorded in the frame memory according to the touch coordinate.

3. The real-time touch input display method according to claim 2, wherein the step of driving the corresponding pixel on the corresponding scan line comprises:
reading the pixel data of the corresponding scan line from the frame memory after changing the corresponding pixel data recorded in the frame memory;
driving the corresponding scan line to turn on the pixels on the corresponding scan line; and
driving the data lines to respectively write the pixel data read from the frame memory into the pixels on the corresponding scan line.

4. The real-time touch input display method according to claim 1 further comprising:
recording a plurality of touch coordinates on a moving path of the touch panel during the touch event; and
driving again the pixels corresponding to the touch coordinates recorded during the touch event after the touch event ends.

5. The real-time touch input display method according to claim 1 further comprising:
recording a plurality of touch coordinates on a moving path of the touch panel into a first memory during the touch event;
selecting one of the scan lines as the corresponding scan line according to the touch coordinates output by the first memory during the touch event; and
driving the corresponding pixel on the corresponding scan line according to the touch coordinates output by the first memory during the touch event.

6. The real-time touch input display method according to claim 5 further comprising:
recording the touch coordinates on the moving path into a second memory during the touch event;
selecting one of the scan lines as the corresponding scan line according to the touch coordinates output by the second memory after the touch event ends and driving the corresponding pixel on the corresponding scan line according to the touch coordinates output by the first memory is completed; and
driving the corresponding pixel on the corresponding scan line according to the touch coordinates output by the second memory after the touch event ends and driving the corresponding pixel on the corresponding scan line according to the touch coordinates output by the first memory is completed.

7. The real-time touch input display method according to claim 1, wherein the PM bistable display is a cholesteric liquid crystal display (ChLCD), an electro-phoretic display (EPD), or a quick response-liquid powder display (QR-LPD).

8. A driving device of a PM bistable display, wherein the PM bistable display has a plurality of scan lines and a plurality of data lines, the driving device comprising:
a scan driver, electrically connected to the scan lines;
a data driver, electrically connected to the data lines;
a touch detection unit, for detecting a touch event of a touch panel to obtain a touch coordinate; and
a display control unit, for controlling the scan driver and the data driver to drive the PM bistable display to display a frame, wherein when the touch event occurs, the display control unit selects one of the scan lines as a corresponding scan line according to the touch coordinate provided by the touch detection unit and drives a corresponding pixel on the corresponding scan line according to the touch coordinate.

9. The driving device according to claim 8, wherein the display control unit comprises:
a frame memory, for recording a plurality of pixel data; and
a display controller, coupled to the frame memory and the touch detection unit, for changing a corresponding pixel data among the pixel data recorded in the frame memory according to the touch coordinate.

10. The driving device according to claim 9, wherein after changing the corresponding pixel data recorded in the frame memory, the display controller reads the pixel data of the corresponding scan line from the frame memory, drives the corresponding scan line to turn on the pixels on the corresponding scan line, and drives the data lines to respectively write the pixel data read from the frame memory into the pixels on the corresponding scan line.

11. The driving device according to claim 8, wherein the display control unit comprises:
a frame memory, coupled to the touch detection unit, for recording a plurality of pixel data and changing a corresponding pixel data among the pixel data recorded in the frame memory according to the touch coordinate; and
a display controller, coupled to the frame memory, wherein after changing the corresponding pixel data recorded in the frame memory, the display controller reads the pixel data of the corresponding scan line from the frame memory, drives the corresponding scan line to turn on the pixels on the corresponding scan line, and drives the data lines to respectively write the pixel data read from the frame memory into the pixels on the corresponding scan line.

12. The driving device according to claim 8, wherein during the touch event, the display control unit records a plurality of touch coordinates on a moving path of the touch panel, and after the touch event ends, the display control unit drives again the pixels corresponding to the touch coordinates recorded during the touch event for at least once.

13. The driving device according to claim 8, wherein the display control unit comprises:
a first memory, coupled to the touch detection unit, for recording a plurality of touch coordinates on a moving path of the touch panel during the touch event; and
a display controller, coupled to the first memory, for selecting one of the scan lines as the corresponding scan line according to the touch coordinates output by the first memory, and for driving the corresponding pixel on the corresponding scan line according to the touch coordinates output by the first memory during the touch event.

14. The driving device according to claim 13 further comprising:
a second memory, coupled between the touch detection unit and the display controller, for recording the touch coordinates on the moving path during the touch event;
wherein after the touch event ends and driving the corresponding pixel on the corresponding scan line according to all the touch coordinates output by the first memory is completed, the display controller selects one of the scan lines as the corresponding scan line according to the touch coordinates output by the second memory and drives the corresponding pixel on the corresponding scan line according to the touch coordinates output by the second memory.

15. The driving device according to claim 8, wherein the PM bistable display is a ChLCD, an EPD, or a QR-LPD.
